(19) United States
(12) Patent Application Publication
(10) Pub. No.: US 2011/0318105 A1
(43) Pub. Date: Dec. 29, 2011

(54) UNDERWATER BREAKWATER FOR EASILY ATTENUATING WAVE ENERGY AND METHOD OF MANUFACTURING ECO-FRIENDLY BLOCKS FOR THE SAME

(75) Inventor: You Ok Yang, Sokcho-si (KR)

(73) Assignee: WOOAM, Yangyang-gun (KR)

(21) Appl. No.: 13/255,762

(22) PCT Filed: Mar. 11, 2010
(86) PCT No.: PCT/KR2010/001524

§ 371 Date: Sep. 9, 2011

(30) Foreign Application Priority Data
Mar. 11, 2009 (KR) 10-2009-0020572
Mar. 10, 2010 (KR) 10-2010-0021336

(51) Int. Cl. E02B 3/08; B28B 1/08; B29C 39/42

(52) U.S. Cl. 405/25; 264/109; 264/71

(57) ABSTRACT

Provided are an underwater breakwater for easily attenuating wave energy and a method of manufacturing eco-friendly blocks for the same. The underwater breakwater includes a plurality of blocks, each of which has a different size and from which spacers protrude so as to form channels in the underwater breakwater, and an energy absorption section that is a pile of the plurality of blocks so as to form at least one root and at least two crests, that attenuates wave energy, and that forms a fishing ground. The energy absorption section reduces the height of waves by attenuating the wave energy by absorbing, distributing, and diffracting the wave energy when the waves move to lower and middle parts thereof, and by attenuating the attenuated wave energy at the second crest by absorbing, distributing, and diffracting the attenuated wave energy when the waves move from the first crest to the root thereof.

### TECHNICAL FIELD

The present invention relates, in general, to an underwater breakwater that attenuates the pressure of waves to prevent coastal erosion and, more particularly, to an underwater breakwater for easily attenuating wave energy and a method of manufacturing eco-friendly blocks for the same, in which the eco-friendly blocks are each manufactured by mixing effective microorganisms (Ems) and yellow soil when concrete mortar is formed, and are piled on the seabed of an inshore area so as to form a root and crests, thereby purifying seawater, preventing red tide from occurring, and thus creating a sea forest in the early stage; in which the wave energy of raging waves is attenuated at lower, middle, and upper layers of the underwater breakwater by absorbing, distributing, and diffracting the wave energy, thereby remarkably reducing the height of waves; and in which an eroded area is recovered by means of a beach nourishment phenomenon.

### BACKGROUND ART

In general, coastal erosion goes on throughout the four seasons of the year due to short-term factors caused by weather conditions such as rainstorms, and long-term factors caused by continuous wave energy and a difference between the ebb and flow of the tide. Coastal erosion takes place to a particularly serious extent due to the wave energy caused by northern and eastern winds that occur in the winter season.

To prevent coastal erosion, breakwater structures are constructed along the coasts. These structures attenuate the wave energy of raging waves rushing on the coasts, thereby producing wide tranquil areas and efficiently protecting the coastlines.

The breakwater structures have an advantage in that they provide places for rest such as sites for fishing that common persons can easily access. However, the breakwater structures are structurally inadequate at absorbing and distributing wave energy. Thus, when wave energy comes up against the breakwater structures, the energy is reflected to form standing waves. This causes serious erosion, and in the worst case the breakwater structures are destroyed and lose their functionality.

Further, the breakwater structures are constructed so as to protrude from the surface of the seawater, so that they worsen the natural landscape and cause the loss of tourist attractions which will contribute to the failure of the local economy.

### Disclosure

### Technical Problem

Accordingly, the present invention has been made keeping in mind the above problems occurring in the related art, and is to provide an underwater breakwater for easily attenuating wave energy, which absorbs, distributes, and diffracts the wave energy of raging waves at the base, middle, and upper layers where a plurality of blocks are piled on the seabed of an inshore area so as to form a root and crests to thereby remarkably reduce the wave height and which allows an eroded area where erosion has occurred to be recovered by means of a beach nourishment phenomenon, and a method of manufacturing eco-friendly blocks for the underwater breakwater.

Further, the present invention serves to provide an underwater breakwater for easily attenuating wave energy, in which a plurality of blocks are piled to form inter- and intra-channels to provide a habitat for marine algae, fish, and shellfish, thereby enriching fish resources, preventing coastal erosion, and forming a fishing ground, and a method of manufacturing eco-friendly blocks for the underwater breakwater.

Further, the present invention serves to provide an underwater breakwater for easily attenuating wave energy and a method of manufacturing eco-friendly blocks for the underwater breakwater, in which, on manufacturing the eco-friendly blocks so as to maintain predetermined strength, effective microorganisms and yellow soil are mixed with concrete mortar, thereby neutralizing the effects of poison of concrete, purifying seawater, preventing red tide from occurring, preventing coastal erosion, and forming a fishing ground.

### Technical Solution

In an aspect, the present invention provides an underwater breakwater for easily attenuating wave energy, which is constructed on a seabed of an inshore area by dropping a plurality of blocks to the seabed to prevent costal erosion and to provide a habitat for marine life, the underwater breakwater includes:

a plurality of blocks, each of which has a different size and from which spacers protrude so as to form channels in the underwater breakwater; and

an energy absorption section that is a pile of the plurality of blocks so as to form at least one root and at least two crests, that attenuates the wave energy, and that forms a fishing ground,

wherein the energy absorption section reduces a height of waves by attenuating the wave energy by absorbing, distributing, and diffracting the wave energy when the waves move to lower and middle parts thereof, and by attenuating the attenuated wave energy at the second crest by absorbing, distributing, and diffracting the attenuated wave energy when the waves move from the first crest to the root thereof.

In another aspect, the present invention provides a method of manufacturing eco-friendly blocks for an underwater breakwater, comprising the steps:

a) mixing 1 to 2 parts of weight of effective microorganisms (Ems) and 2 to 3 parts of weight of underwater concrete stabilizer with 100 parts of weight of pure yellow soil;

b) mixing 100 parts of weight of fine aggregate and 200 parts of weight of coarse aggregate with the mixture of the step a);

c) mixing 100 parts of weight of cement with the mixture of the step b);

d) mixing 200 parts of weight of water with the mixture of the step c) to form concrete mortar;

e) pouring the concrete mortar of the step d) into a form; and

f) spraying the concrete mortar poured into the form of the step e) with water so as to cure the concrete mortar.

### Advantageous Effects

According to the underwater breakwater for easily attenuating wave energy and the method of manufacturing eco-friendly blocks for the same, the wave energy of waves is more effectively attenuated by absorbing, distributing and diffracting the wave energy when the waves pass through the energy absorption section formed by the plurality of blocks piled on the seabed of the inshore area, so that it can reliably prevent formation of standing waves, reduce the wave height to relieve the wave pressure at the beach, and thus prevent the coastal erosion, as well as to recover areas that have eroded and where erosion occurs by means of the phenomenon of nourishing the beach.

Further, according to the underwater breakwater for easily attenuating wave energy and the method of manufacturing eco-friendly blocks for the same, the inter- and intra-channels between the blocks are provided by the space between the spacers of each block and the space between the communication holes of each block so as to allow fish to move, so that the breakwater can provide a habitat and a spawning ground for fish and shellfish and so promote the smooth growth of the fish to enrich fish resources.

According to the underwater breakwater for easily attenuating wave energy and the method of manufacturing eco-friendly blocks for the same, the effective microorganisms and the yellow soil are mixed with the concrete mortar when each block is formed, thereby neutralizing the effects of poison of concrete, purifying seawater, and preventing red tide from occurring. Further, the blocks are made by a mixture of cement, coarse aggregate, and fine aggregate so as to maintain the strength of concrete, so that the blocks can be prevented from being damaged and be easily piled to form the breakwater when the blocks are dropped on the inshore area.

### DESCRIPTION OF DRAWINGS

FIG. 1 is a perspective view showing a block to which the present invention is applied.

FIG. 2 is a cross-sectional view of FIG. 1.

FIGS. 3 and 4 show how to construct an underwater breakwater having an energy absorption section with blocks according to the present invention.

FIGS. 5 and 6 show how wave energy is attenuated by the present invention.

FIG. 7 shows how erosion is recovered by the present invention.

FIG. 8 shows how a fishing ground is produced by the underwater breakwater according to the present invention.

### LISTS OF SYMBOLS USED FOR MAIN PARTS OF THE DRAWINGS

100: underwater breakwater
110, 110′: block
111, 111′: body
112, 112′: communication hole
113, 113′: spacer
120: energy absorption section
121: root
122: crest

### MODE FOR INVENTION

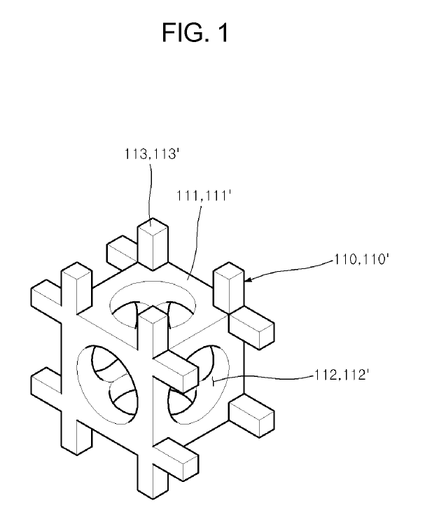

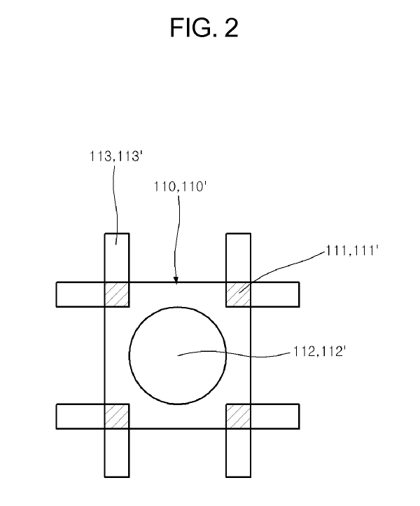

Reference will now be made in greater detail to an exemplary embodiment of the invention with reference to the accompanying drawings. FIG. 1 is a perspective view showing a block to which the present invention is applied, and FIG. 2 is a cross-sectional view of FIG. 1.

An inventive underwater breakwater for easily attenuating wave energy is an underwater breakwater 100 that is constructed on the seabed of an inshore area by dropping a plurality of blocks onto the seabed to prevent costal erosion and to provide a habitat for marine life. Each block in the plurality of blocks 110 and 110′ that is provided has a different size. Also, spacers 113 and 113′ protrude from the plurality of blocks 110 and 110′ so as to form channels in the underwater breakwater 100. The plurality of blocks 110 and 110′ are piled up to form at least one root 121 and at least two crests 122 and 122′ so as to serve as an energy absorption section 120 that attenuates the wave energy and forms a fishing ground. The underwater breakwater 100 is designed to reduce the height of waves by attenuating the wave energy at the energy absorption section 120, particularly by absorbing, distributing, and diffracting the wave energy when waves move to lower and middle parts of the energy absorption section 120, and by absorbing, distributing, and diffracting the wave energy at the second crest 122′ when the waves move from the first crest 122 to the root 121 of the energy absorption section 120. This will be described below in greater detail.

The blocks 110 and 110′ include bodies 111 and 111′ in which communication holes 112 and 112′ are formed so as to communicate with each other up and down, left and right, and back and forth, and a plurality of spacers 113 and 113′ that protrude from the bodies 111 and 111′ so as to be able to maintain channels.

Further, the blocks 110 and 110′ are molded from either steel or reinforced concrete.

In addition, the blocks 110 and 110′ are preferably molded with yellow soil mixed.

Now, a method of manufacturing the blocks of the present invention which is configured as described above will be described.

First, the block 110 is molded. Dry yellow soil is put through a sieve to remove foreign materials such as leaves. 100 parts of weight of pure yellow soil are uniformly mixed with 1 to 2 parts of weight of EMs and 2 to 3 parts of weight of underwater concrete stabilizer. Here, EMs are abbreviated from effective microorganisms, and refer to useful microorganisms such as yeasts, lactic acid bacteria, green molds, photosynthetic bacteria, actinomycetes, etc., which can purify water and prevent metal oxidation.

Further, 100 parts of weight of the mixture are uniformly mixed with 100 parts of weight of fine aggregate and 200 parts of weight of coarse aggregate. When concrete mortar is prepared, these fine and coarse aggregates serve to maintain basic strength of the block when combined with the yellow soil.

100 parts of weight of cement is uniformly mixed with the mixture to which the fine and coarse aggregates are added. The cement serves to increase a bonding force of the fine aggregate, the coarse aggregate and the yellow soil. These constituent materials are preferably mixed using a mixer.

200 parts of weight of water is mixed with the mixture to which the cement is added, thereby forming concrete mortar. The concrete mortar is poured into a form for molding the block 110.

Here, the form is a Euro-form and a steel form. The form is preferably formed so that its interior is open up and down, left and right, and back and forth, and a plurality of spacer cavities are formed in respective corners.

When the concrete mortar is poured into the form, the form is vibrated using a vibrator so that the concrete mortar can be densely filled in the form. The concrete mortar is cured for about two weeks. When the concrete mortar is cured, the concrete mortar is covered with a curing blanket, and is repetitively sprayed with water, so that it is possible to prevent cracks of the block 110 and enhance durability of the block 110.

When the concrete mortar is completely cured, the form is separated from the cured concrete mortar. As a result, the block 110 has a hollow hexahedral body 111, communication holes 112 formed in respective faces of the body 111, and spacers 113 protruding from the body 111. The block 110 is preferably configured so that each communication hole 112 has a diameter of about 1 meter and that a length of each face is more than 2.5 meters.

Here, the block 110 may be molded from steel and reinforced concrete.

Further, the block 110′ is molded by the above-mentioned method from steel and/or reinforced concrete so as to have a hollow hexahedral body 111′, communication holes 112′ formed in respective faces of the body 111′, and spacers 113′ protruding from the body 111′. The block 110′ is preferably configured so that each communication hole 112′ has a diameter of about 0.5 meters and that a length of each face is less than 2.5 meters, more preferably 1.5 meters so as to be able to be disposed between the spacers 113 of the block 110.

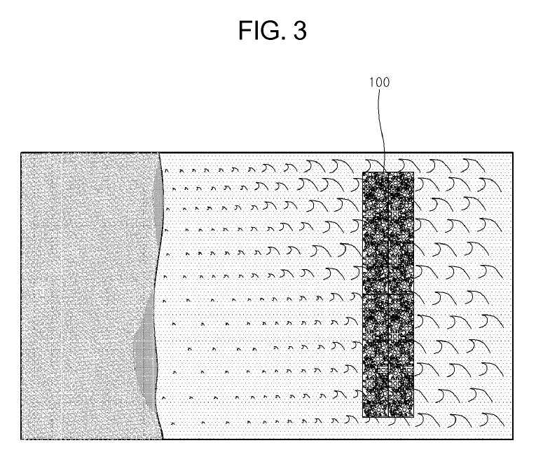

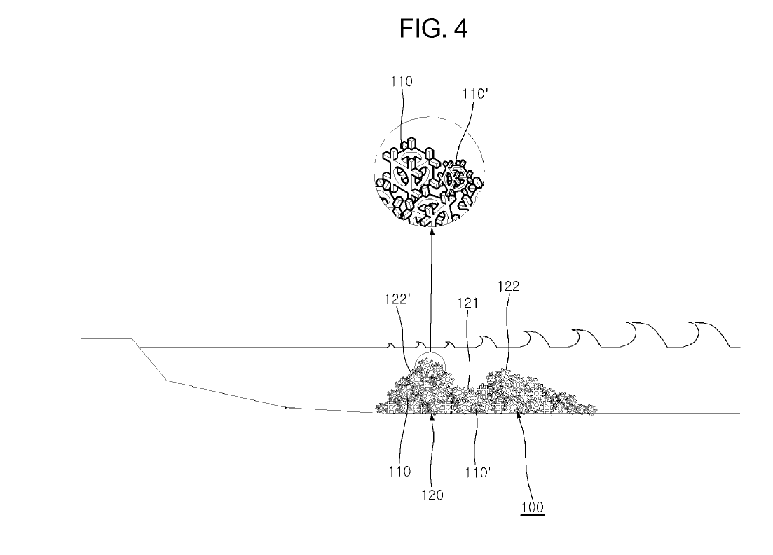

The numerous blocks 110 and 110′ molded by the above-mentioned method are loaded on a barge, and then are transported to an inshore area spaced apart some distance from a coast undergoing erosion, i.e. a spot where the underwater breakwater 100 is constructed, as shown in FIGS. 3 and 4. Then, the blocks 110 and 110′ are dropped to the seabed one by one using a crane, thereby forming an energy absorption section 120.

Here, the blocks 110 and 110′ sink into the seabed due to their weight. The boundary of the submerged blocks 110 and 110′ is measured. In the meantime, the blocks 110 and 110′ are piled up to form the energy absorption section 120. The energy absorption section 120 is preferably formed so that it has a different length, width, and height under various conditions such as a coastal eroded area, a wave height, wave intensity, and so on.

Further, the energy absorption section 120 has a root 121 and first and second crests 122 and 122′ that are opposite to each other centering on the root 121. When the first and second crests 122 and 122′ are flush with the surface of the seawater, the effect of attenuating the wave energy such as wave pressure is the greatest. When the blocks 110 and 110′ are piled up, intervals between the first and second crests 122 and 122′ and the surface of seawater are preferably set within a range from about 1 meter to 1.5 meters so as to prevent ships from being wrecked when the ships are in motion. More preferably, the interval between the second crest 122′ and the surface of the seawater is less than or equal to the interval between the first 122 and the surface of seawater.

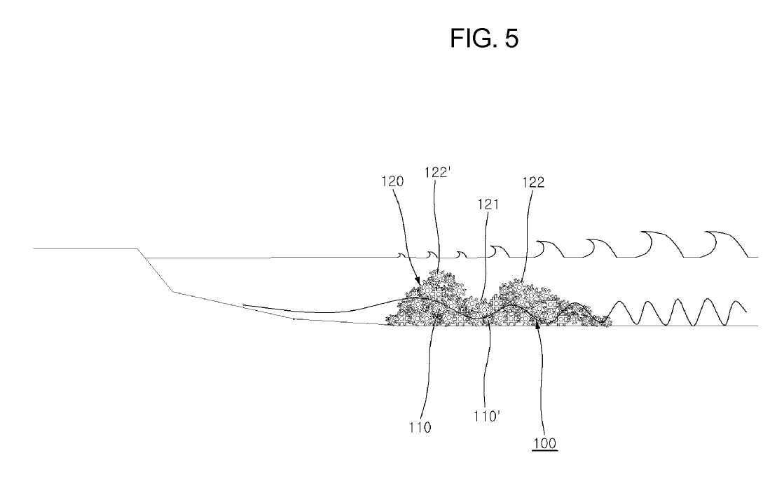

As shown in FIG. 5, when waves rush on the energy absorption section 120 of the underwater breakwater 100 formed in the abovementioned process, the waves hitting the lower and middle parts of the energy absorption section 120 enter into the front communication holes 112 and 112′ formed in the front faces of the blocks 110 and 110′ and then are discharged into the rear, left and right, and upper and lower opposite communication holes 112 and 112′. The discharged waves flow into and out of the communication holes of other blocks. The process of the waves flowing through the numerous blocks disposed by the width of the energy absorption section 120 is repeated. Thereby, it is possible to distribute and absorb the wave energy such as wave pressure.

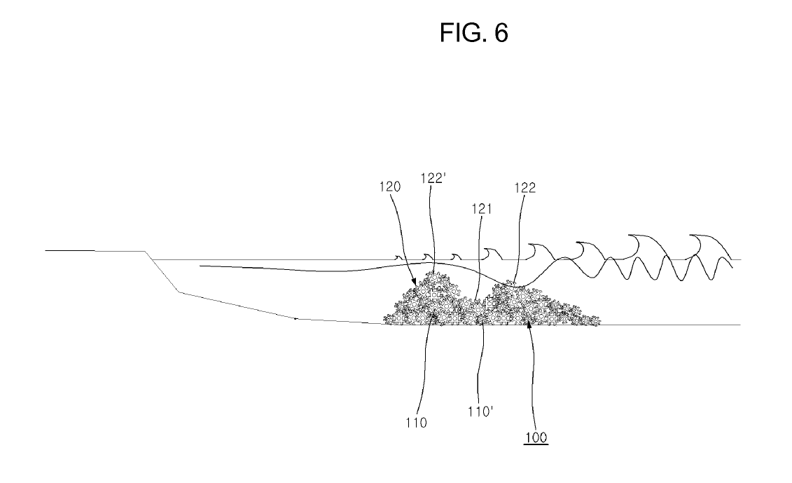

Further, as shown in FIG. 6, the waves rushing on an upper end of the energy absorption section 120 run against the first crest 122 of the energy absorption section 120 to rise toward the surface of seawater, and simultaneously flow into and out of the communication holes 112 and 112′ of the blocks 110 and 110′ around the first crest 122. This process is repeated, so that it is possible to distribute and absorb the waves, and thus to attenuate the wave energy such as the wave pressure.

The waves running against the first crest 122 are partially lowered toward the root 121, and simultaneously flow into and out of the communication holes 112 and 112′ of the blocks 110 and 110′ around the root 121. This process is repeated, so that it is possible to distribute and absorb the wave energy, and thus to attenuate the wave energy such as the wave pressure.

Further, the waves passing through the root 121 continue to rise toward the surface of seawater past the second crest 122′, and simultaneously flow into and out of the communication holes 112 and 112′ of the blocks 110 and 110′ around the second crest 122′. This process is repeated, so that it is possible to distribute and absorb the wave energy, and thus to attenuate the wave energy. Since the interval between the second crest 122′ and the surface of seawater is less than or equal to the interval between the first 122 and the surface of seawater, the wave energy of the waves passing the first crest 122 is again distributed, absorbed, and diffracted. This process of attenuating the wave energy is repeated, so that it is possible to reduce the height of the waves.

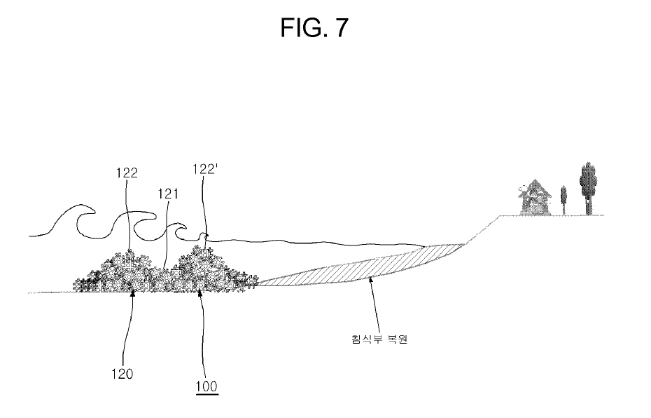

In detail, the wave energy of the waves is attenuated by from 50% to 70% when the waves pass through the lower and middle parts of the energy absorption section 120, and then by 50% or more when the waves pass through the first crest 122. The attenuated wave energy is further attenuated by from 20% to 30% when the waves pass through the second crest 122′. As a result, it is possible to reduce the wave height and weaken the wave pressure at the beach, and thus to prevent coastal erosion. As shown in FIG. 7, due to the energy absorption section 120, it is possible to induce the recovery of an eroded area between the coast and the energy absorption section 120.

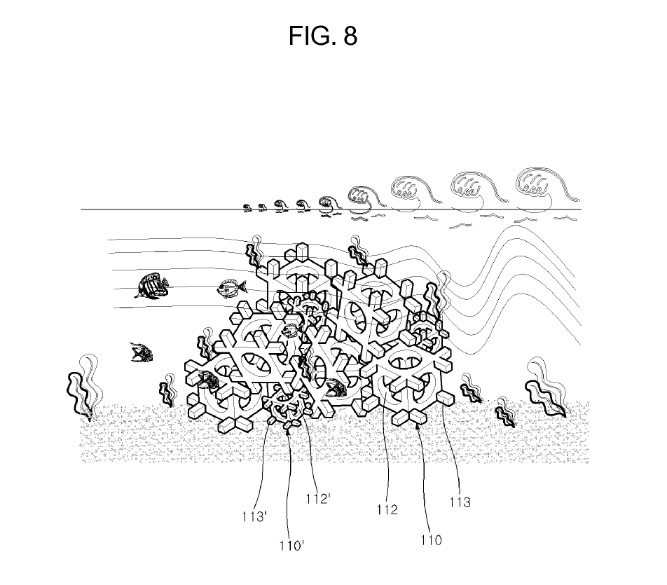

Further, as shown in FIG. 8, the blocks 110 and 110′ of the energy absorption section 120 make it possible to maintain channels therebetween corresponding to the protruding length of the spacers 113 and 113′, and allow fish to move through the communication holes 112 and 112′ thereof. As such, the blocks 110 and 110′ can provide a habitat and a spawning ground for fish and shellfish as well as a space where aquatic plants can easily grow, i.e. a fishing ground, and enrich fish resources.

The yellow soil mixed into the blocks 110 and 110′ forming the underwater breakwater 100 is allowed to purify seawater, prevent red tide from occurring, and easily harmonize with surrounding environment due to the color of natural soil. The EMs mixed into the blocks 110 and 110′ neutralizes the effects of poison of concrete and inhibit decomposition due to an antioxidation action, so that they can prevent water pollution.

In the above description, the embodiments of the present invention have been disclosed for illustrative purposes with reference to the accompanying drawings. Here, the technical terms and words used in the specification and claims must not be interpreted according to the limited definitions thereof, such as their ordinary or dictionary meanings, but must be understood to represent meanings and concepts corresponding to the technical scope and spirit of the invention. Thus, those skilled in the art will appreciate that the construction of the embodiments and drawings of the invention has been disclosed as that of exemplary embodiments, and thus various modifications, additions and substitutions are possible, without departing from the scope and spirit of the invention as disclosed in the accompanying claims.

1. An underwater breakwater for easily attenuating wave energy, which is constructed on a seabed of an inshore area by dropping a plurality of blocks to the seabed to prevent costal erosion and to provide a habitat for marine life, the underwater breakwater comprising:
a plurality of blocks, each of which has a different size and from which spacers protrude so as to form channels in the underwater breakwater; and
an energy absorption section that is a pile of the plurality of blocks so as to form at least one root and at least two crests, that attenuates the wave energy, and that establishes a fishing ground,
wherein the energy absorption section reduces a height of waves by attenuating the wave energy by absorbing, distributing, and diffracting the wave energy when the waves move to lower and middle parts thereof, and by attenuating the attenuated wave energy at the second crest by absorbing, distributing, and diffracting the attenuated wave energy when the waves move from the first crest to the root thereof.

2. The underwater breakwater according to claim 1, wherein each block includes a body in which communication holes are formed so as to communicate with each other up and down, left and right, and back and forth, and a plurality of spacers that protrude from the body so as to be able to maintain channels.

3. The underwater breakwater according to claim 2, wherein each block is formed of one of steel and reinforced concrete.

4. The underwater breakwater according to claim 1, wherein the second crest has a height greater than or equal to that of the first crest so as to attenuate the wave energy.

5. The underwater breakwater according to claim 4, wherein the plurality of blocks are piled up and submerged so that the second crest is spaced apart from a surface of seawater by from 1 meter to 1.5 meters.

6. The underwater breakwater according to claim 2, wherein each block includes yellow soil.

7. A method of manufacturing eco-friendly blocks for an underwater breakwater, comprising the steps:
a) mixing 1 to 2 parts of weight of effective microorganisms (Ems) and 2 to 3 parts of weight of underwater concrete stabilizer with 100 parts of weight of pure yellow soil;
b) mixing 100 parts of weight of fine aggregate and 200 parts of weight of coarse aggregate with the mixture of the step a);
c) mixing 100 parts of weight of cement with the mixture of the step b);
d) mixing 200 parts of weight of water with the mixture of the step c) to form concrete mortar;
e) pouring the concrete mortar of the step d) into a form; and
f) spraying the concrete mortar poured into the form of the step e) with water so as to cure the concrete mortar.

8. The method according to claim 7, wherein, when the concrete mortar of the step e) is poured, the form is vibrated by a vibrator.
